(19) United States
(12) Patent Application Publication
(10) Pub. No.: US 2007/0078557 A1
(43) Pub. Date: Apr. 5, 2007

(54) Apparatus for measuring uniformity of a laminar material

(75) Inventors: Niall Finn, Lethbridge (AU); Andrzej Stanislaw Krajewski, Belmont (AU)

Correspondence Address: MERCHANT & GOULD PC, P.O. BOX 2903, MINNEAPOLIS, MN, 55402-0903, US

(73) Assignee: Commonwealth Scientific and Industrial Research Organisation, Campbell (AU)

(21) Appl. No.: 10/551,498

(22) PCT Filed: Apr. 1, 2004
(86) PCT No.: PCT/AU04/00424

§ 371 Date: Aug. 8, 2006

(30) Foreign Application Priority Data
Apr. 3, 2003 (AU) 2003901632

(51) Int. Cl. G06F 19/00

(52) U.S. Cl. 700/143; 702/159

(57) ABSTRACT

There is described apparatus for measuring uniformity of a laminar material (1) as the material is delivered from a laminar material delivery machine (2), the apparatus has a measurement rig (10) arranged across the width of the laminar material. The measurement rig carries a linear array of light sources (21) arranged to direct light onto the laminar material (1), a linear array of optical sensors (20), each optical sensor (20) being paired with a light source (21) and being configured to receive light reflected by the laminar material (1) from at least the light source (21) with which it is paired and to thereafter produce a signal indicative of the amount of reflected light it receives, and a processor (11) for receiving signals from each of the optical sensors (20) and processing each of the signals to produce measures of uniformity of the linear material (1) for each optical sensor (20), whereby said apparatus produces measures of uniformity related to spaced apart locations across the width of the laminar material (1).

### FIELD OF THE INVENTION

The present invention relates to apparatus for measuring uniformity of a laminar material as the material is delivered from a laminar material delivery machine. The present invention has particular application in measuring web aerial density uniformity or variation of a textile web.

### BACKGROUND TO THE INVENTION

In the field of non-woven textile processes, the uniformity of the web which is used to form the fabric is critical to the fabric's performance. For example, variations in web density result in variations in tensile properties, filtration properties, and visual appearance. Even in processes where a textile web is cross-lapped in many layers, the uniformity of the web still dictates the final uniformity of the fabric. In many processes, the web is not cross-lapped and the uniformity of the web then defines the uniformity of the product. Since specifications on products often dictate a minimum strength for all sub-samples of a product, poor uniformity can mean that even when the average strength is quite adequate, extra material must be used in order to meet a minimum strength requirement. Therefore, the ability to monitor the uniformity of the web in real-time would be extremely valuable to many manufacturers. For example, so processes can be adjusted in order to optimise uniformity. Uniformity of other laminar materials is also critical, for example cardweb uniformity in the woollen spinning process and the semi-worsted process.

It would be desirable for such a system to provide an accurate measure of web uniformity over as wide a range of web aerial density as possible and with high spatial resolution. Further, it would also be desirable for such a system to measure webs of material at high speed, for example at 200 m/min with little or no loss in resolution. While it would be ideal that the apparatus provided an absolute measure of web aerial density, a relative measure will often be satisfactory as this can, for example, provide feedback to a machine for keeping an average web density constant against long term variations and allow it to measure short term density fluctuations along and across the web.

There have previously been a number of attempts to provide devices for measuring uniformity of a web including a laser scanner which uses a retro-reflector located under the web which returns the laser signal to the webscanner. Such devices typically have low resolution and/or only suitable when the laminar material moves at low speed. Further, geometrical effects at the scan edges affect the maximum web weight that can be measured. Other major disadvantages are that the reflector under the web must be kept clean and that lasers are relatively expensive devices.

Video systems are also known. These devices are generally designed for fault identification such as the location of contaminants or holes and generally not used for density fluctuations. These devices are expensive and complex and require considerable analysis of signals. These devices require light sources located under the web which again can be difficult to keep clean. Further, such devices will produce geometrical effects at scan edges that can affect maximum web weight that can be measured and can also lead to distortion due to foreshortening of the observed image.

Accordingly, it would be advantageous to provide an alternative apparatus for measuring uniformity of a laminar material such as a textile web.

### SUMMARY OF THE INVENTION

The present invention provides an apparatus for measuring uniformity of a laminar material as the material is delivered from a laminar material delivery machine, the apparatus comprising:

a measurement rig arranged across the width of the laminar material, the measurement rig carrying:
a linear array of light sources arranged to direct light onto the laminar material; and
a linear array of optical sensors, each optical sensor being paired with a light source and being configured to receive light reflected by the laminar material from at least the light source with which it is paired and to thereafter produce a signal indicative of the amount of reflected light it receives; and

a processor for receiving signals from each of the optical sensors and processing each of the signals to produce measures of uniformity of the linear material for each optical sensor, whereby said apparatus produces measures of uniformity related to spaced apart locations across the width of the laminar material.

Typically, the laminar material is a textile web and the measure of uniformity is a measure of web aerial density.

It is preferred that each light source and optical sensor pair are arranged with their major optical axes substantially perpendicularly to the direction of travel of the laminar material. It is preferred that the major optical axes are offset to perpendicular such that they intersect at the web, with the bisector of the optical axes being perpendicular to the web.

Preferably, said light sources are LEDs.

The optical sensor may receive light reflected by the laminar material from LEDs adjacent the LED with which it is paired.

Preferably, said processor receives a signal indicative of the amount of light received at each optical sensor at predetermined intervals. The outputs of the sensors are typically read sequentially to thereby produce a raster scan of the textile web.

Preferably, the LEDs are excited individually and the signal is taken from each optical sensor while its corresponding LED is excited.

Preferably, the predetermined interval between scans is chosen so that the distance the web travels between scans matches the separation between adjacent sensors. The apparatus may comprise a speed sensor for monitoring the speed of the web delivery system and the processor may determine said intervals from the monitored speed.

Preferably, the measurement rig comprises a mounting block within which the light sources and the optical sensors are mounted.

Preferably the optical sensors are mounted within individual holes and set back from an aperture of their respective hole which faces the laminar material.

Preferably, the light sources are mounted within an elongate slot extending the length of the mounting block whereby light sources may provide illumination for more optical sensors adjacent to the optical sensor with which they are paired.

Preferably, the optical axes of the light sources and sensors intersect approximately 50 mm below the measurement rig.

The apparatus may be used to generate control signals for another part of the process.

The invention also provides apparatus for measuring uniformity of a laminar material as the material is delivered from a laminar material delivery machine, the apparatus comprising:

a measurement rig arranged across the width of the laminar material, the measurement rig carrying:
a linear array of light sources arranged to direct light onto the laminar material, and
a linear array of optical sensors, each optical sensor being paired with a light source and being configured to receive light transmitted through the laminar material from at least the light source with which it is paired and to thereafter produce a signal indicative of the amount of transmitted light it receives; and
a processor for receiving signals from each of the optical sensors and processing each of the signals to produce measures of uniformity of the linear material for each optical sensor, whereby said apparatus produces measures of uniformity related to spaced apart locations across the width of the laminar material.

In one embodiment, the apparatus may include arrays of light sources arranged on opposite sides of the laminar material and two arrays of optical sensors also arranged on opposite sides of the material, whereby said apparatus can produce measures of uniformity based on light transmitted in one or both directions.

### BRIEF DESCRIPTION OF THE DRAWINGS

FIG. 1 is a schematic view showing the general arrangement of the apparatus of the present invention;

FIG. 2 is a top view of the measurement rig of the present invention;

FIG. 3 is a side view of the measurement rig of the preferred embodiment of the invention;

FIG. 4 is a bottom view of the measurement rig of the preferred embodiment;

FIG. 5 is a cross-sectional end view of the measurement rig of the preferred embodiment; and

FIG. 6 is a schematic view of an apparatus of an alternative embodiment.

### DESCRIPTION OF THE PREFERRED EMBODIMENT

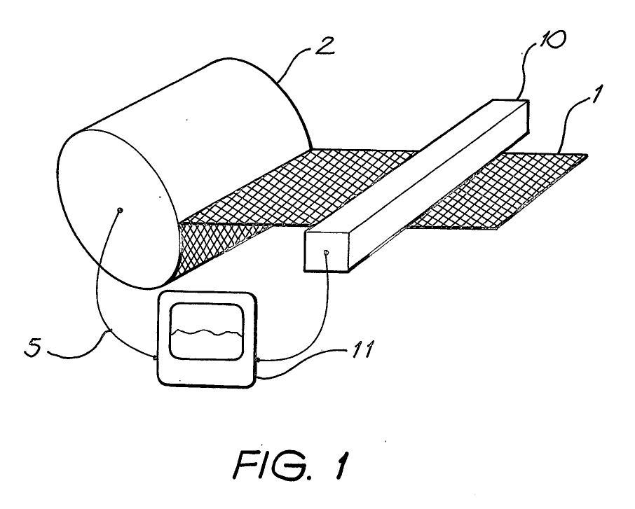

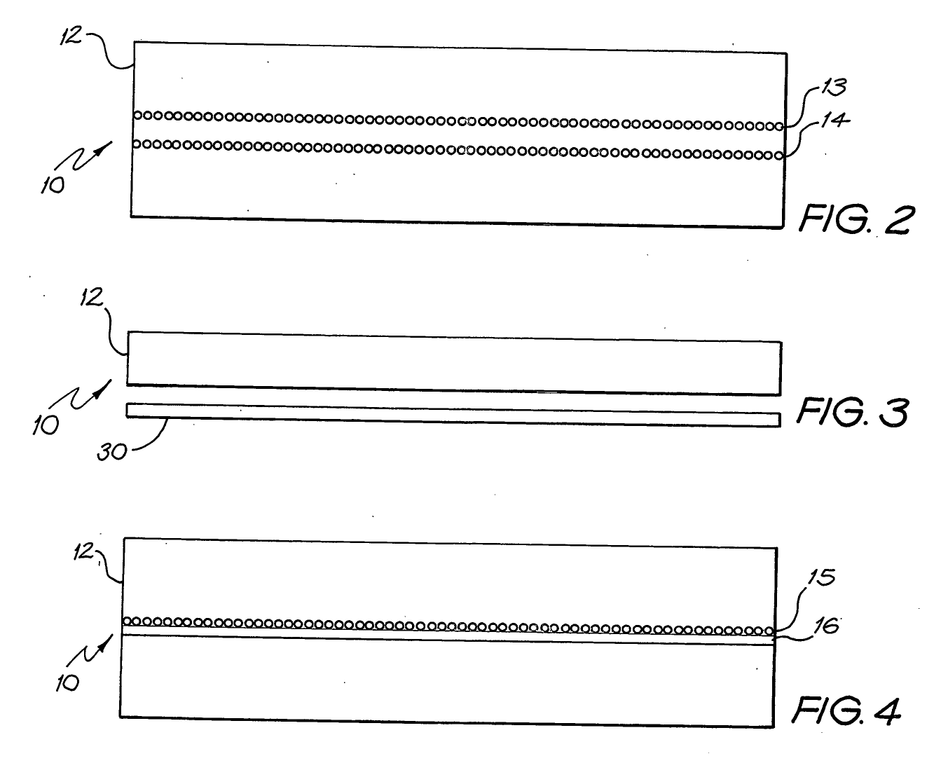

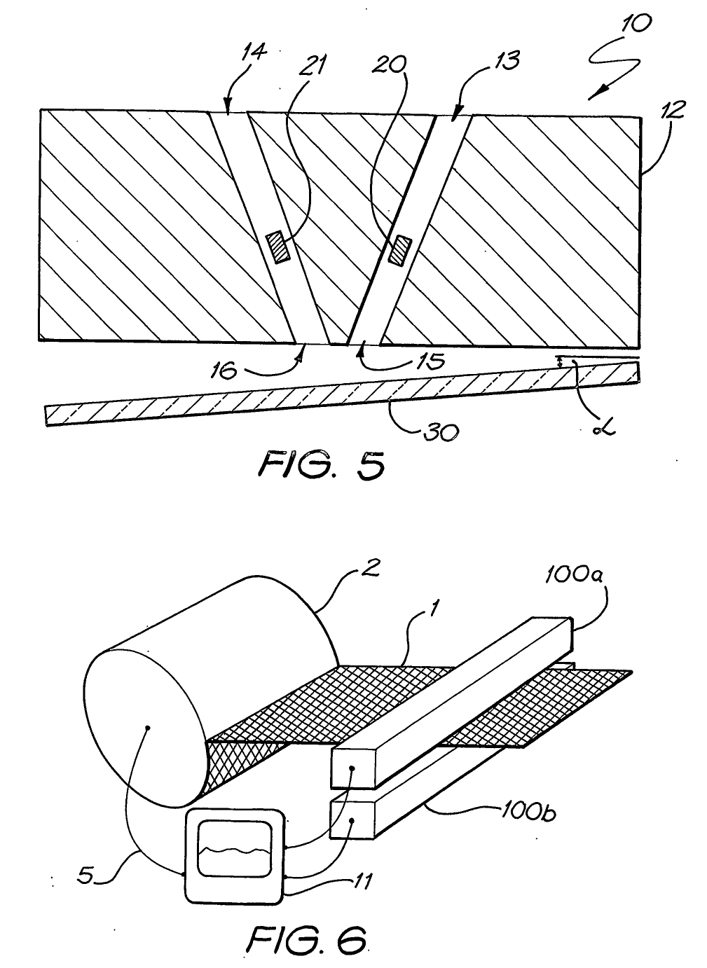

Referring to FIG. 1, there is shown schematically an apparatus for measuring uniformity of a laminar material of a preferred embodiment. In the preferred embodiment, the apparatus is designed to measure uniformity of a textile web 1 as the web 1 is delivered from a textile web delivery machine 2. The apparatus has two major components:

(1) a measurement rig 10 located across the width of the laminar material 1; and

(2) a processor 11 for processing signals produced by the measurement rig 10.

The measurement rig 10 is mounted so that it can be raised and lowered relative to the laminar material.

In the preferred embodiment, measurement rig 10 consists of six modules each having a linear array of 64 optical sensors mounted within 64 holes each having an upper aperture 13 and each hole terminating in a lower aperture 15 located above the web 1. The optical sensors 20 are set back from the lower aperture 15 in order to limit their field of view. Each of the optical sensors 20 is paired with one of a corresponding array of 64 light sources 21, which in the preferred embodiment take the form of light emitting diodes (LEDs) 21 so that the measurement rig 10 carries multiples of 64 LED/optical sensor pairs. The LEDs 21 are also mounted within holes extending from upper aperture 15 and terminating in a slot which is 10 mm deep. The slot enables neighbouring LEDs 21 to provide light which depending on the mode of operation can be received by neighbouring optical sensors 21.

In the preferred embodiment, the mounting block is approximately 385 mm long with the optical centre of adjacent LED/sensor pairs is 6 mm apart.

Persons skilled in the art can select appropriate LEDs and optical sensors, however it is preferred that the optical sensors and LEDs be matched in spectral output and spectral response in order that the device has maximum sensitivity.

In the preferred embodiment, the LEDs 21 are sequentially energised by voltage pulses under control of the processor and the sensors are sequentially read into a multiplexer and analogue/digital converter so that a raster scan is performed of the web 1 passing under the measurement rig 10. The resulting signals are indicative of the amount of reflected light received by the respective optical sensors. In order to process the signals quickly to produce a measure of uniformity, the optical sensors are coupled to a digital signal processor (DSP) and subsequently to a personal computer (PC). That is, the processor 11 has a DSP and a PC. The digital signal processor enables multiple simultaneous processing of the respective signals.

In the preferred embodiment, the LEDs are excited by pulses in order to allow greater light output during the time that the corresponding sensor is addressed and read without damage to the LED 21. This also leads to reduced power consumption compared to running all of the LEDs and sensors continuously.

In the preferred embodiment the optical axes of the LEDs and sensors are arranged to intersect at about 50 mm below the top of the mounting block. Accordingly, the web is preferentially positioned in this position.

The device includes a timing circuit so that the signals are taken from the sensors and fed to the data line feeding the DSP. By sequentially energising the LEDs and reading the responses of the sensors while the web passes below the measurement rig 10, the spatial variations in density of the web can be converted to time variations in electrical signals that can subsequently be digitized and processed to provide measures of the uniformity of the web 1.

In the preferred embodiment the apparatus is one sided so that it is arranged solely above the web 1 and does not require anything below the web 1 such as a retro reflective strip that needs to be cleaned. Further, each LED-sensor pair is set directly above the web 1 and measures the web at an angle normal to the web 1 in the travel direction. This avoids there being any variance in the angle of view across the web 1.

The apparatus is configured to complete in an entire scan of all LED/sensor pairs in a time less than 1.8 ms. Thus, for web delivery machine 2 delivering a web 1 travelling at 200 m/min, the time between scans will allow the web 1 to travel 6 mm thus matching the physical cross-wise sensor separation and defining the spatial resolution of the device. At very high speeds the distance traveled may exceed the desired distance of 6 mm, nevertheless the apparatus will still provide a useful measure of web aerial density.

The scans can be triggered by an internal clock at a fixed frequency or can be triggered by a speed signal produced by a speed sensor of the web delivery machine 2 and sent over signal line 5 so that each scan is separated by a fixed but adjustable distance from the next. The fixed scan-frequency method is used for correlating faults in the web with some process parameters that vary in fixed temporal frequencies for instances rotating rollers earlier in the process. An alternate mode of operation in running with a fixed distance between scans is useful for comparing and monitoring the spatial variations and density of the web regardless of its speed. It allows for greater confidence in monitoring web quality while the line speed is varied.

The measurement rig also carries a glass sheet 30, arranged at an angle α of 2.5 degrees to the plane of the mounting block. When the measurement rig 10 is raised a calibration signal can be obtained by measuring the relatively small portion of light reflected from the glass. The calibration signal is subsequently used to correct the measure of uniformity. Persons skilled in the art will appreciate that other transparent materials may be substituted for glass. Similarly, the angle α can be varied to alter the amount of reflected light.

Persons skilled in the art will appreciate the number of variations maybe made to the invention without departing from the scope of the invention. For example, more than sixty four LED-sensor pairs can be used in each module of measurement rig. However, a person skilled in the art will appreciate that the number of modules or LED/sensor parts in each module can be varied.

While it is preferred that the measurement rig be disposed to only one side and to avoid a construction where debris will fall on to either the optical sensors or the light sources, as shown in FIG. 6, measurement rigs 100a, 100b can be mounted on both sides of the web. In this configuration, while it is possible that the array of light sources could be mounted on one side of the material and the array of optical sensors can be mounted on the other side, it is preferred that light sources and optical sensors be provided on both sides of the laminar material.

Persons skilled in the art will appreciate that the outputs of the above apparatus can be used not only to produce measurements of uniformity but also to derive control signals which could control previous aspects of the process. Further, it will be appreciated that the outputs could be used for additional functions such as width control of the edges or to control edge cutting devices for width and position after measuring before and after a bonding oven for instance. In this instance, measurement before the cutters would fix their position with respect to the fabric centre, while their separation is fixed by measurement after the bonding oven to account for shrinkage in the oven. This would allow the cutter to be adjusted so that the edges could be cut prior to bonding or colouration as the waste of this product can be recycled more easily because it is either unbonded or uncoloured.

These and various other uses, together with various modifications will be apparent to persons skilled in the art and should be considered as falling within the scope of the invention described herein.

1. Apparatus for measuring uniformity of a laminar material as the material is delivered from a laminar material delivery machine, the apparatus comprising:
a measurement rig arranged across the width of the laminar material, the measurement rig carrying:
a linear array of light sources arranged to direct light onto the laminar material; and
a linear array of optical sensors, each optical sensor being paired with a light source and being configured to receive light reflected by the laminar material from at least the light source with which it is paired and to thereafter produce a signal indicative of the amount of reflected light it receives; and
a processor for receiving signals from each of the optical sensors and processing each of the signals to produce measures of uniformity of the linear material for each optical sensor, whereby said apparatus produces measures of uniformity related to spaced apart locations across the width of the laminar material.

2. Apparatus as claimed in claim 1, wherein each light source and optical sensor pair are arranged with their major optical axes substantially perpendicularly to the direction of travel of the laminar material.

3. Apparatus as claimed in claim 2, wherein said major optical axes of each light source and optical sensor pair are offset to perpendicular such that they intersect at the web, with the bisector of their optical axes being perpendicular to the web.

4. Apparatus as claimed in claim 1, wherein said light sources are light emitting diodes (LEDs).

5. Apparatus as claimed in claim 1, wherein said processor is configured to obtain a signal indicative of the amount of light received at each optical sensor at predetermined intervals.

6. Apparatus as claimed in claim 5, wherein the outputs of the sensors are read sequentially by said processor to thereby produce a raster scan of the textile web.

7. Apparatus as claimed in claim 4, wherein said measurement rig excites said LEDs individually and the signal from each optical sensor corresponds to the period during which the optical sensors paired LED is excited.

8. Apparatus as claimed in claim 6, wherein the predetermined interval between scans is chosen so that the distance the web travels between scans matches the separation between adjacent sensors.

9. Apparatus as claimed in claim 8, wherein said apparatus comprises a speed sensor for monitoring the speed of the web delivery system and said processor determines the pre-determined interval from the monitored speed.

10. Apparatus as claimed in claim 1, wherein the measurement rig comprises a mounting block within which the light sources and the optical sensors are mounted.

11. Apparatus as claimed in claim 10, wherein the optical sensors are mounted within individual holes and set back from an aperture of their respective hole which faces the laminar material.

12. Apparatus as claimed in claim 10, wherein the light sources are mounted within an elongate slot extending the length of the mounting block whereby light sources may provide illumination for optical sensors adjacent to the optical sensor with which they are paired.

13. Apparatus as claimed in claim 2, wherein the optical axes of the light sources and sensors intersect approximately 50 mm below the measurement rig.

14. Apparatus as claimed in claim 1, wherein said measurement rig carries a sheet of transparent material between said linear array of light sources and the laminar material, the transparent material being angled to the plane of the scanner, whereby a portion of the light from the light sources can be reflected to said optical sensors, and processed to produce a calibration measure.

15. Apparatus as claimed in claim 14, wherein said measurement rig is mounted so it can be lifted relative to said web to perform a calibration.

16. Apparatus as claimed in claim 1, wherein said processor is configured to produce a measure of uniformity in the form of a measure of web aerial density whereby said apparatus is configured to produce measures of uniformity for a laminar material which is a textile web.

17. Apparatus for measuring uniformity of a laminar material as the material is delivered from a laminar material delivery machine, the apparatus comprising:
a measurement rig arranged across the width of the laminar material, the measurement rig carrying:
a linear array of light sources arranged to direct light onto the laminar material, and
a linear array of optical sensors, each optical sensor being paired with a light source and being configured to receive light transmitted through the laminar material from at least the light source with which it is paired and to thereafter produce a signal indicative of the amount of transmitted light it receives; and
a processor for receiving signals from each of the optical sensors and processing each of the signals to produce measures of uniformity of the linear material for each optical sensor, whereby said apparatus produces measures of uniformity related to spaced apart locations across the width of the laminar material.

18. Apparatus as claimed in claim 17, comprising two arrays of light sources arranged on opposite sides of the laminar material and two arrays of optical sensors also arranged on opposite sides of the material each light source and optical sensor being paired with a light source on the opposite side of the laminar material, whereby said apparatus can produce measures of uniformity based on light transmitted in one or both directions.

19. Apparatus as claimed in claim 17, wherein each light source and optical sensor pair are arranged with their major optical axes substantially perpendicularly to the direction of travel of the laminar material.

20. Apparatus as claimed in claim 19, wherein said major optical axes are offset to perpendicular such that they intersect at the web, with the bisector of the optical axes being perpendicular to the web.

21. Apparatus as claimed in claim 17, wherein said light sources are light emitting diodes (LEDs).

22. Apparatus as claimed in claim 17, wherein said processor is configured to obtain a signal indicative of the amount of light received at each optical sensor at predetermined intervals.

23. Apparatus as claimed in claim 22, wherein the outputs of the sensors are read sequentially by said processor to thereby produce a raster scan of the textile web.

24. Apparatus as claimed in claim 1, wherein the LEDs are excited individually and the signal is taken from each optical sensor while its corresponding LED is excited.

25. Apparatus as claimed in claim 22, wherein the predetermined interval between scans is chosen so that the distance the web travels between scans matches the separation between adjacent sensors.

26. Apparatus as claimed in claim 25, comprising a speed sensor for monitoring the web delivery system and wherein said processor determines said interval from the monitored speed.
